(19) United States
(12) Patent Application Publication
(10) Pub. No.: US 2026/0161022 A1
(43) Pub. Date: Jun. 11, 2026

(54) OPTICAL WAVEGUIDE ELEMENT, AND OPTICAL MODULATION DEVICE AND OPTICAL TRANSMISSION DEVICE WHICH USE SAME

(71) Applicant: SUMITOMO OSAKA CEMENT CO., LTD., Tokyo (JP)

(72) Inventors: Hideki ICHIMEI, Tokyo (JP); Yu KATAOKA, Tokyo (JP)

(73) Assignee: SUMITOMO OSAKA CEMENT CO., LTD., Tokyo (JP)

(21) Appl. No.: 18/851,323

(22) PCT Filed: Feb. 10, 2023
(86) PCT No.: PCT/JP2023/004535

§ 371 Date: Sep. 26, 2024

(51) Int. Cl. G02F 1/035; G02B 6/12; G02B 6/125; G02F 1/03

(52) U.S. Cl. CPC G02F 1/035; G02B 6/12004; G02B 6/125; G02F 1/0316; G02B 2006/12107; G02B 2006/12111; G02B 2006/12142

(57) ABSTRACT

An object of the present invention is to provide an optical waveguide device that reduces noise light input into a light-receiving element.

An optical waveguide device includes a substrate 1 on which an optical waveguide 2 is formed, the optical waveguide 2 including a main waveguide 2 and a branched waveguide 5 branching from a part of the main waveguide, a diffraction grating GT disposed in an end portion of the branched waveguide 5, a light-receiving element PD disposed on the substrate for receiving a light wave diffracted by the diffraction grating, and a metal film MET1 disposed on the substrate to surround the diffraction grating.

### TECHNICAL FIELD

The present invention relates to an optical waveguide device, and an optical modulation device and an optical transmission apparatus using the same, and particularly to an optical waveguide device including a substrate on which an optical waveguide is formed.

### BACKGROUND ART

In the field of optical communication or in the field of optical measurement, optical waveguide devices such as an optical modulator that is obtained by forming an optical waveguide on a substrate of lithium niobate (LN) or the like having an electro-optic effect and that is provided with a modulation electrode which modulates a light wave propagating through the optical waveguide have been widely used.

In recent optical modulation devices such as a high bandwidth-coherent driver modulator (HB-CDM), it has been required to incorporate a driver circuit that drives the optical waveguide device into a case together with the optical waveguide device and furthermore, to reduce a size of the entire package. In a case of disposing the driver circuit on one end side of the optical waveguide device and inputting a high-frequency signal into the optical waveguide device, it has been suggested to dispose an input portion for inputting the light wave and an output portion for outputting the light wave together on another end side of the optical waveguide device.

Patent Literature No. 1 suggests a method of easily specifying a location in which an optical loss such as a propagation loss or a coupling loss has occurred in an optical waveguide even in an optical waveguide device having a small size. Specifically, as illustrated in FIG. 1, the optical waveguide device includes a substrate 1 on which a folded optical waveguide 2 is formed, a grating 6 formed in a part of the optical waveguide 2 or a grating 6 connected to a monitoring optical waveguide that merges with a part of the optical waveguide or branches from a part of the optical waveguide, in which a light wave is input into the optical waveguide from a light source (LD), or at least a part of a light wave propagating through the optical waveguide is output and received by light-receiving elements (PD1 and PD2).

In order to reduce the size of the optical waveguide device, a mode field diameter (MFD) of the folded optical waveguide 2 is set to approximately 1 μm which is small.

Thus, a spot size converter SSC is provided in an end portion of the optical waveguide 2 to increase MFD to 3 μm or higher.

Patent Literature No. 1 also suggests, as illustrated in FIG. 2, disposing a light absorption member AB1 such as a metal on a rear side of the light-receiving elements in order to absorb high-order diffraction light or multiple reflection light of the high-order diffraction light from the grating 6 that cannot be received by the light-receiving element PD1 (PD2). A configuration of disposing the grating 6 at a tip end of a branched waveguide 5 branching from the optical waveguide 2 and disposing a light absorption member AB 2 downstream of the grating 6 in order to absorb noise light leaking from the grating 6 is also disclosed, as illustrated in FIG. 3.

In manufacturing the optical modulation device, for example, as illustrated in FIG. 4, an optical member OB such as an optical fiber or a lens LEN is attached to the optical waveguide device including the substrate 1 on which the folded optical waveguide 2 is formed. In order to increase accuracy of attachment of the optical element OB, inspection light LO is input from the specific lens LEN, and the optical element OB is adjusted to maximize light-receiving sensitivity of a monitor PD provided on an optical waveguide device chip.

In a case where the light absorption members (AB1 and AB2) are disposed at positions illustrated in FIG. 2 or 3, the light absorption members (AB1 and AB2) are suitable for removing the noise light that has passed through the monitor PD. However, as in FIG. 4, in a structure of the optical waveguide device including the folded optical waveguide, a position of the monitor PD is close to an end of the optical waveguide 2 closer to an input waveguide. Thus, a leaked light beam (refer to reference sign LT2 in FIG. 5) of the input light is likely to be input into monitors (PD1 and PD2). While a state near the light-receiving element PD is illustrated in an enlarged manner in FIG. 5, a leaked light beam LT1 generated at a branch point of the branched waveguide 5 branching from the main waveguide 2 through which main light such as signal light propagates may be input into a diffraction grating (grating) GT. Thus, a position of the optical member OB with which the light-receiving sensitivity of the monitor PD is maximized may not always be an optimal position of the optical element.

FIG. 6 is an enlarged plan view of the diffraction grating GT. Protruding and recessed portions are regularly disposed in a fan shape in an end portion of the branched waveguide 5. A light wave traveling in a direction of arrow A is designed to turn immediately upward from the diffraction grating GT (in a direction perpendicular to the drawing) and is optimized for a light-receiving surface of the light-receiving element PD.

Generally, an angle α of spreading in a fan shape from arrow A of the diffraction grating is set to an angle of approximately 7°.

From a structural characteristic of the diffraction grating, in a case where stray light IL1 traveling in the same direction as the direction of arrow A or stray light IL4 traveling in the opposite direction to the direction of arrow A is input into the diffraction grating GT, the stray light IL1 or the stray light IL4 turns immediately upward from the diffraction grating and is input into the light-receiving element PD as noise. A turning effect of the diffraction grating is strongest for the stray light (IL1 and IL4), second strongest for stray light IL2, and lowest for stray light IL3 that is input in a position relationship of being at almost a right angle to arrow A.

Thus, the leaked light beam LT1 from a branching part between the main waveguide 2 and the branched waveguide 5 and the leaked light beam LT2 of the light input into the optical waveguide 2 in FIG. 5 turn at the diffraction grating GT and are likely to be noise of the light-receiving element.

### CITATION LIST

### Patent Literature

[Patent Literature No. 1] Japanese Laid-open Patent Publication No. 2022-155813

### SUMMARY OF INVENTION

### Technical Problem

An object to be solved by the present invention is to solve the above problem and provide an optical waveguide device that reduces noise light input into a light-receiving element. It is also an object to provide an optical modulation device and an optical transmission apparatus using the optical waveguide device.

### Solution to Problem

In order to solve the object, an optical waveguide device, an optical modulation device, and an optical transmission apparatus of the present invention have the following technical features.
(1) An optical waveguide device includes a substrate on which an optical waveguide is formed, the optical waveguide including a main waveguide and a branched waveguide branching from a part of the main waveguide, a diffraction grating disposed in an end portion of the branched waveguide, a light-receiving element disposed on the substrate for receiving a light wave diffracted by the diffraction grating, and a metal film disposed on the substrate to surround the diffraction grating.
(2) In the optical waveguide device according to (1), the metal film is configured as a part of an electrode formed on the substrate.
(3) In the optical waveguide device according to (1), the metal film is disposed on at least a straight line connecting a branch point at which the branched waveguide branches from the main waveguide to the diffraction grating.
(4) In the optical waveguide device according to (1), an angle formed by a direction in which the main waveguide extends at a branch point at which the branched waveguide branches from the main waveguide and a tangential direction in the end portion of a curve formed by the branched waveguide is 40 degrees or higher.
(5) In the optical waveguide device according to (1), in a plan view of the substrate, the metal film includes a pattern having a part in which the metal film is not disposed along a part of an edge of the light-receiving element, and the pattern also serves as means for positioning the light-receiving element.
(6) In the optical waveguide device according to (1), in a plan view of the substrate, the metal film includes a first metal film that has at least a part disposed inside the light-receiving element, and a second metal film that is configured with only a part disposed outside the light-receiving element and that has a part surrounding the first metal film, and the second metal film is set to have a larger thickness than the first metal film.
(7) In the optical waveguide device according to (6), an electrode formed on the substrate has a shape of multiple tiers, and the first and the second metal films are formed by the metal film of any tier constituting the electrode.
(8) In the optical waveguide device according to (1), a thickness of the metal film disposed inside the light-receiving element in a plan view of the substrate is 2 μm or lower.
(9) An optical modulation device includes the optical waveguide device according to any one of (1) to (8), a case accommodating the optical waveguide device, and an optical fiber through which a light wave is input into the optical waveguide device or output from the optical waveguide device.
(10) In the optical modulation device according to (9), a modulation electrode that modulates a light wave propagating through the optical waveguide is provided in the substrate, and an electronic circuit that amplifies a modulation signal to be input into the modulation electrode is provided inside or outside the case.
(11) An optical transmission apparatus includes the optical modulation device according to (10), and an electronic circuit that outputs a modulation signal causing the optical modulation device to perform a modulation operation.

### Advantageous Effects of Invention

According to the present invention, an optical waveguide device includes a substrate on which an optical waveguide is formed, the optical waveguide including a main waveguide and a branched waveguide branching from a part of the main waveguide, a diffraction grating disposed in an end portion of the branched waveguide, a light-receiving element disposed on the substrate for receiving a light wave diffracted by the diffraction grating, and a metal film disposed on the substrate to surround the diffraction grating. Thus, for example, stray light such as a leaked light beam radiating from a branching part between the main waveguide and the branched waveguide is absorbed by the metal film, and reaching of the stray light to the diffraction grating is suppressed. Consequently, an optical waveguide device that reduces noise light input into a light-receiving element can be provided. An optical modulation device and an optical transmission apparatus using the optical waveguide device having such an effect can also be provided.

### BRIEF DESCRIPTION OF DRAWINGS

FIG. 1 is a plan view illustrating an example of an optical waveguide device according to Patent Literature No. 1.

FIG. 2 is a side view for describing an optical waveguide and a grating in the optical waveguide device according to Patent Literature No. 1.

FIG. 3 is a plan view for describing a state where a light absorption member (an electrode or the like) is disposed after the grating in the optical waveguide device according to Patent Literature No. 1.

FIG. 4 is a plan view for describing positional adjustment of an optical member OB with respect to an optical waveguide 2.

FIG. 5 is a diagram for describing a state where a leaked light beam is input into a diffraction grating provided in a branched waveguide.

FIG. 6 is a diagram for describing an example of a diffraction grating used in an optical waveguide device of the present invention.

FIG. 7 is a diagram for describing a first example of the optical waveguide device of the present invention.

FIG. 8 is a diagram for describing a second example of the optical waveguide device of the present invention.

FIG. 9 is a cross-sectional view taken along alternate long and short dash line IX-IX in FIG. 8.

FIG. 10 is a diagram for describing an angle at which the diffraction grating in FIG. 7 is disposed.

FIG. 11 is a diagram illustrating an application example of FIG. 10.

FIG. 12 is a diagram for describing an example in which a slit is provided in a first metal film MET1 in the example in FIG. 8.

FIG. 13 is a diagram for describing an example in which a light-receiving element PD is positioned using the first metal film MET1 in the example in FIG. 8.

FIG. 14 is a diagram for describing another example of positioning of the light-receiving element PD illustrated in FIG. 13.

FIG. 15 is a diagram for describing an example in which the diffraction grating is disposed in only one of two branched waveguides.

FIG. 16 is a diagram illustrating a state where a part of a light wave branching from a multi-mode interference waveguide (MMI) 20 is guided to the light-receiving element PD.

FIG. 17 is a diagram for describing the optical waveguide device in which an input portion and an output portion of the light wave are formed on opposite sides of a substrate 1 (chip).

FIG. 18 is a diagram for describing the optical waveguide device in which the input portion and the output portion of the light wave are formed on adjacent sides of the substrate 1 (chip).

FIG. 19 is a plan view illustrating an optical modulation device and an optical transmission apparatus according to the present invention.

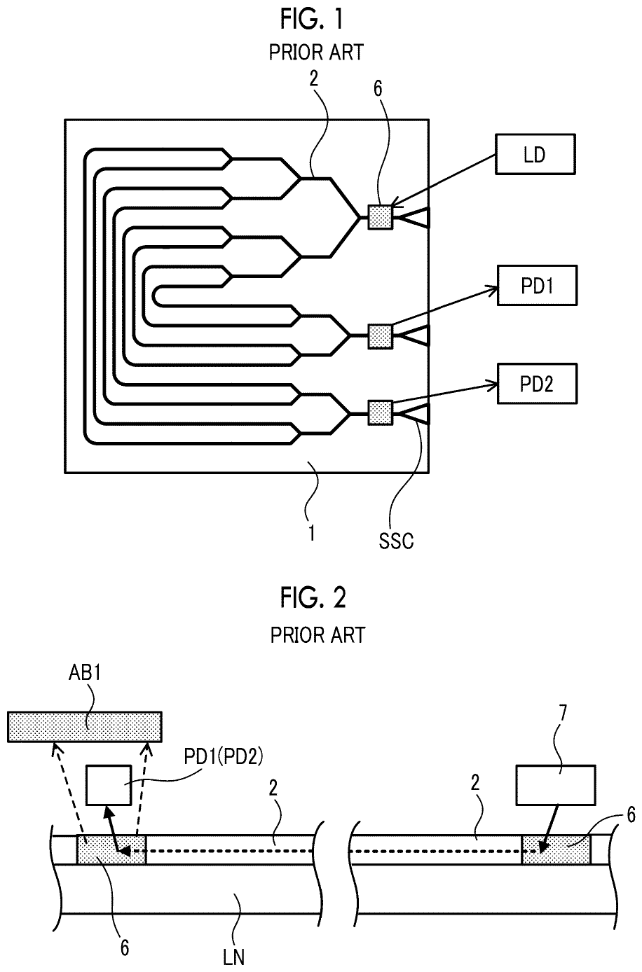

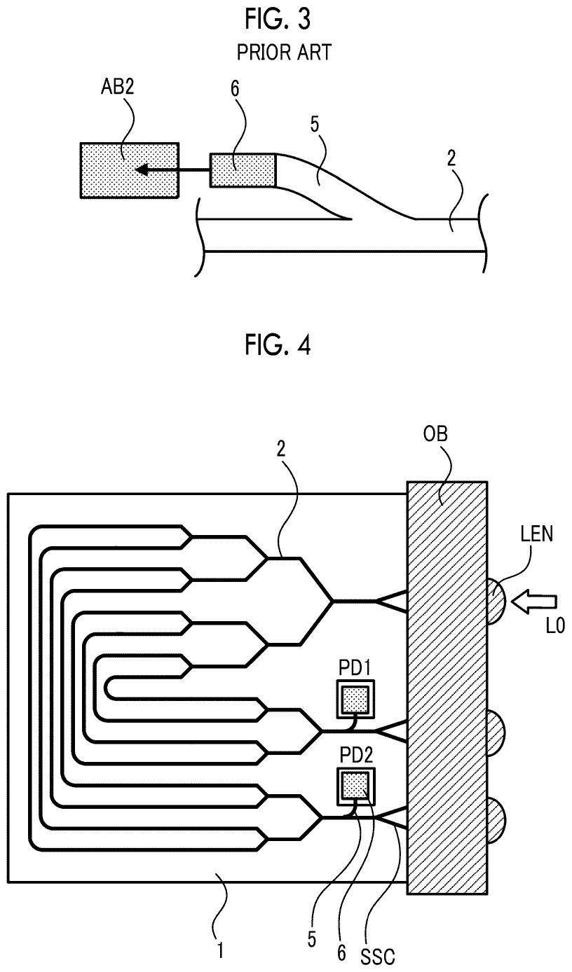

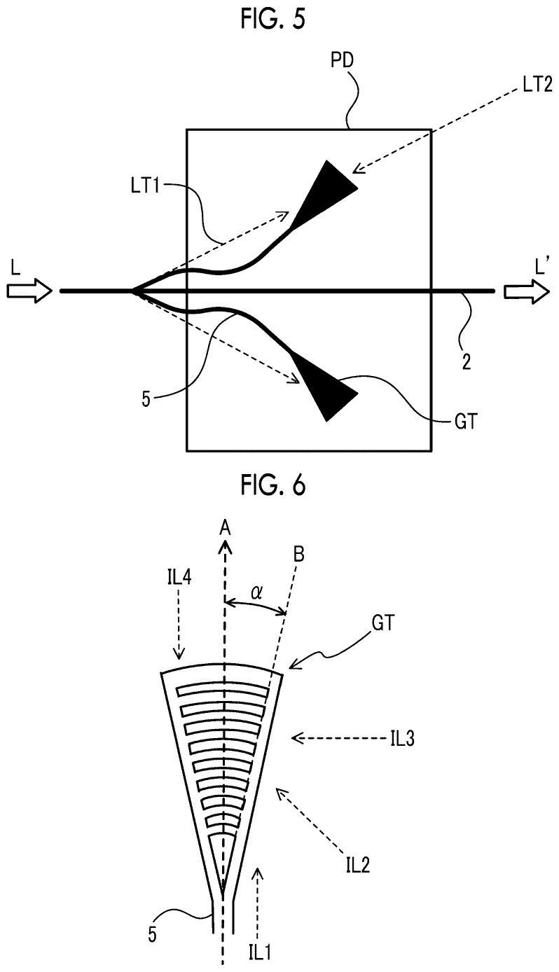

### DESCRIPTION OF EMBODIMENTS

Hereinafter, the present invention will be described in detail using preferred examples.

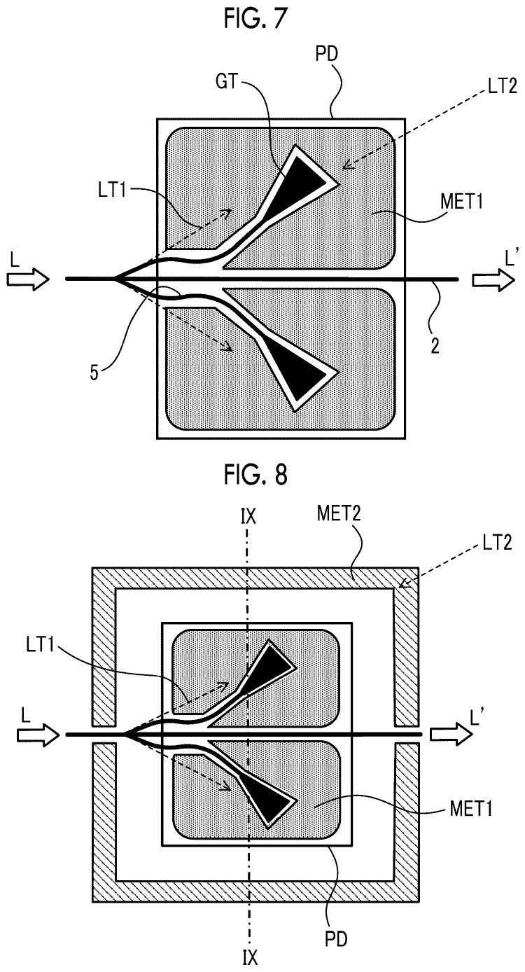

In the present invention, as illustrated in FIGS. 7 and 8, an optical waveguide device includes a substrate 1 on which an optical waveguide 2 is formed, the optical waveguide 2 including a main waveguide 2 and a branched waveguide 5 branching from a part of the main waveguide, a diffraction grating GT disposed in an end portion of the branched waveguide 5, a light-receiving element PD disposed on the substrate for receiving a light wave diffracted by the diffraction grating, and a metal film MET1 disposed on the substrate to surround the diffraction grating.

As the substrate 1, a substrate of lithium niobate (LN), lithium tantalate (LT), lead lanthanum zirconate titanate (PLZT), or the like having an electro-optic effect, a vapor-phase growth film formed of these materials, a composite substrate obtained by joining these materials to different types of substrates, or the like can be used.

Various materials such as semiconductor materials and organic materials can also be used.

As a method of forming the optical waveguide, a rib optical waveguide in which a part of the substrate corresponding to the optical waveguide is formed to have a protruding shape by, for example, etching a surface of the substrate other than the optical waveguide and forming grooves on both sides of the optical waveguide can be used. By using a horizontal slot waveguide in which a slot waveguide structure is formed in a thickness direction by thinning the substrate, a bending loss can be reduced.

The optical waveguide can also be formed by forming a high-refractive index part on the surface of the substrate with Ti or the like using a thermal diffusion method, a proton exchange method, or the like. A composite optical waveguide can also be formed by, for example, diffusing a high-refractive index material in the rib optical waveguide part. Particularly, in a case of using a folded optical waveguide, a protruding waveguide that exhibits strong light confinement and that has a width or height of approximately 1 μm is used.

In order to achieve velocity matching between a microwave of a modulation signal and the light waves, a thin film substrate is produced from the substrate on which the optical waveguide is formed, using a method of forming a thin plate by grinding and polishing up to a thickness of 10 μm or lower, more preferably 5 μm or lower, and still more preferably lower than 1 μm (a lower limit of the thickness is preferably 0.3 μm or more) or a smart cut method (a method of forming a thin film by ion implantation and peeling). A height of the rib optical waveguide is preferably set to 1 μm or lower. Alternatively, a vapor-phase growth film can be formed on a holding substrate to have a thickness of approximately that of the substrate, and the film can be processed to have the above shape of the optical waveguide.

The substrate (a thin plate or a thin film) on which the optical waveguide is formed is adhesively fixed to the holding substrate through direct joining or an adhesive layer of a resin or the like in order to increase mechanical strength. As the holding substrate to be directly joined, a material, for example, quartz, that has a lower refractive index than the optical waveguide and the substrate on which the optical waveguide is formed and that has a similar coefficient of thermal expansion to the optical waveguide or the like is suitably used. In joining to the holding substrate through an intermediate layer having a low refractive index, the same material as the substrate on which the optical waveguide is formed, for example, an LN substrate, can be used as a reinforcing substrate, or a substrate of silicon or the like having a high refractive index can be used as the holding substrate. The “substrate” in the present invention is also a concept including the holding substrate.

As a feature of the optical waveguide device of the present invention, the metal film is disposed to surround the diffraction grating disposed in the end portion of the branched waveguide.

FIG. 7 is a plan view for describing a first example related to the optical waveguide device of the present invention. While a lower portion of the light-receiving element PD is not visible in an original structure, the light-receiving element PD is illustrated as being transparent so that the metal film MET1 and the diffraction grating GT are seen. Reference sign L denotes a light wave input into the optical waveguide 2 in a region of interest, and reference sign L′ denotes a light wave output from the optical waveguide 2.

A leaked light beam LT1 from a branch point at which the main waveguide 2 and the branched waveguide 5 branch from each other, a leaked light beam LT2 from an input portion of the optical waveguide 2 formed in the optical waveguide device, and the like may be input into the diffraction grating GT. Particularly, the leaked light beam LT1 is generated near the diffraction grating GT. Thus, by disposing the metal film MET1 to surround the diffraction grating, input of the leaked light beam LT1 into the diffraction grating can be securely suppressed. Particularly, as illustrated in FIG. 7, by disposing the metal film MET1 on at least a straight line connecting the branch point at which the branched waveguide 5 branches from the main waveguide 2 to the diffraction grating GT, reaching of the leaked light beam LT1 from the branch point to the diffraction grating GT can be suppressed.

Reaching of the leaked light beam LT2 from the input portion of the optical waveguide device and the like to the diffraction grating GT can also be suppressed by the metal layer MET1.

In order to effectively suppress a leaked light beam (stray light) such as the leaked light beam LT2 that is generated from a location other than the branch point and that reaches the diffraction grating GT, a second metal film can be further disposed to surround the first metal film MET1, as illustrated in FIG. 8.

In a plan view of the substrate 1, the first metal film MET1 is a metal film that has at least a part disposed inside the light-receiving element PD. As will be described later, the first metal film MET1 may include a part protruding outside the light-receiving element PD.

The second metal film MET2 is a metal film that is configured with only a part disposed outside the light-receiving element PD and that has a part surrounding the first metal film MET1.

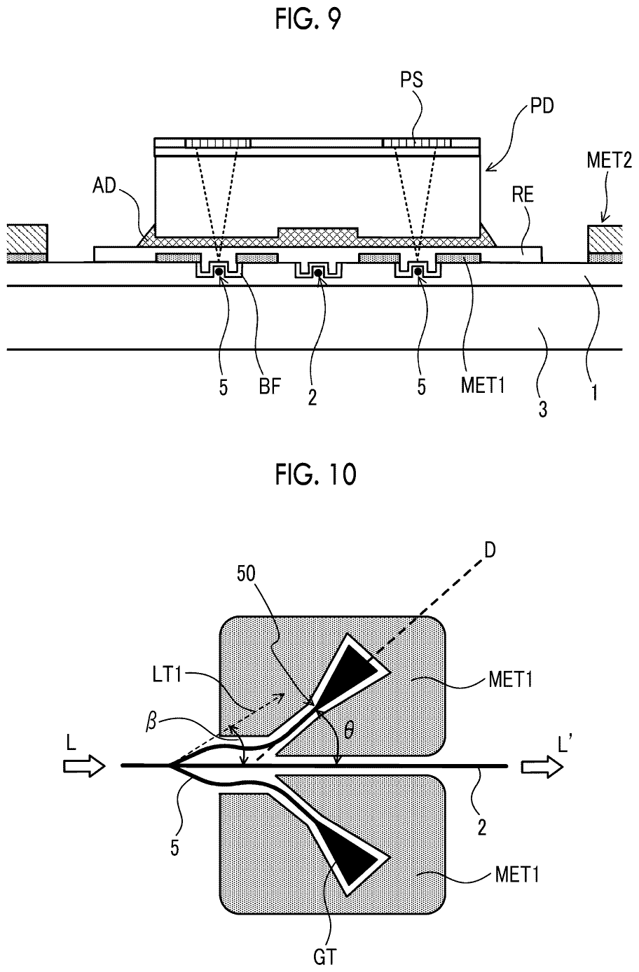

FIG. 9 illustrates a summary of a cross-sectional view taken along alternate long and short dash line IX-IX in FIG. 8.

In FIG. 9, the substrate 1 on which the optical waveguide 2 is formed is formed on an upper surface of a holding substrate 3. The branched waveguide 5 is formed such that the main waveguide 2 at a center is interposed in the branched waveguide 5, and any of an organic dielectric body or an inorganic dielectric body having a lower refractive index than the substrate 1 is provided around the optical waveguide 2 and the branched waveguide 5. In a case where an organic dielectric body is used, a resin such as a resist that has a low Young's modulus and that is easily patternable is desired. For example, a material such as a polyamide-based resin, a melamine-based resin, a phenol-based resin, an amino-based resin, or an epoxy-based resin is provided. In a case where an inorganic dielectric body is used, SiO₂, SiN, Al₂O₃, MgF, La₂O₃, Zno, MgO, CaF₂, Y₂O₃, or the like is provided.

By providing this buffer layer BF, scattering losses of light of the optical waveguide 2 and the branched waveguide 5 can be reduced, and this effect improves an optical loss characteristic.

The first metal film MET1 is disposed such that the branched waveguide 5 is interposed in the first metal film MET1. A resist RE is further disposed to cover the optical waveguide 2. The resist can also be disposed in contact with the optical waveguide by removing the buffer layer. By forming the resist RE, an effect of increasing installation accuracy (horizontality) using an upper surface of the resist RE is expected in mounting the light-receiving element PD. The light-receiving element PD is fixed with an adhesive AD.

A light wave directed upward from the diffraction grating GT (not illustrated in FIG. 9) disposed in the end portion of the branched waveguide 5 is input into the light-receiving element PD disposed on an upper side of the substrate 1. In the light-receiving element PD, light-receiving surfaces PS having a photoelectric conversion function are provided at two locations in accordance with two diffraction gratings. While the two light-receiving surfaces PS may be configured to individually output monitoring signals, the two light-receiving surfaces can be formed into one light-receiving surface in an integrated manner, as necessary, and two light waves obtained from the two diffraction gratings can be combined and output as a monitoring signal.

The first metal film MET1 and the second metal film MET2 are not particularly limited as long as the first metal film MET1 and the second metal film MET2 are formed of a material such as Au that can absorb a light wave. However, in a case where the same material as a control electrode such as a modulation electrode and a DC bias electrode disposed on the substrate of the optical waveguide device is used, the metal films (MET1 and MET2) can be formed using a manufacturing process of forming the control electrode.

In a case where the control electrode is formed to have a shape of multiple tiers by laminating a plurality of electrode layers (a state where positions of protruding end portions are different for each tier like a shape of a staircase), the first metal film and the second metal film can also be configured as a combination of different tiers (electrode layers).

A thickness of the first metal film MET1 is 2 μm or lower, more preferably 1 μm or lower, and still more preferably lower than 0.7 μm. A lower limit of the thickness is preferably 0.3 μm or higher. The first metal film MET1 has a part positioned on a lower side of the light-receiving element PD. Thus, in a case where the thickness is small, a permanent resist or the like can be used, and the permanent resist can be disposed on the first metal film MET1. This enables the light-receiving element and the optical waveguide to be accurately mounted parallel to each other. In a case where the thickness of the metal film is excessively small, light absorption performance is decreased. Thus, it is preferable to secure the above thickness.

As illustrated in FIGS. 8 and 9, the first metal film MET1 is disposed close to the main waveguide 2 and the branched waveguide 5. Thus, a distance between the optical waveguide and the metal film need to be accurately controlled. Thus, an electron beam (EB) lithography device is used to pattern an EB resist. However, for the EB resist, forming the pattern on a thickness of 2 μm or higher requires an enormous amount of time, which is not practical. The EB resist is also used for forming an electrode layer of a first tier or a specific tier of the control electrode (the modulation electrode and the DC bias electrode) disposed close to the optical waveguide. Thus, it is preferable to form the first metal layer in accordance with formation of the electrode layer of the tier using the EB resist in the control electrode.

As illustrated in FIG. 9, a thickness of the second metal film MET2 is preferably configured to be larger than the thickness of the first metal film MET1. Particularly, an upper surface of the second metal film MET2 is preferably positioned at a position higher than a position of a lower surface of the light-receiving element PD. This enables not only a light wave propagating inside the substrate 1 but also a light wave propagating through a space above the substrate 1 to be efficiently blocked in a case where a leaked light beam (stray light) is input into a region of the second metal film MET2 from an outside of the second metal film. In order to improve an electrical bandwidth and a high-frequency characteristic, the thickness of the second metal film MET2 is preferably set to be large.

In a case of forming the second metal film MET2 to be thick, a thickness of, for example, approximately 8 to 30 μm can be provided by forming a pattern on a photoresist using an ultraviolet exposure device, as in the case of the control electrode. Of course, the second metal layer can also be formed in generating the specific electrode layer of the control electrode.

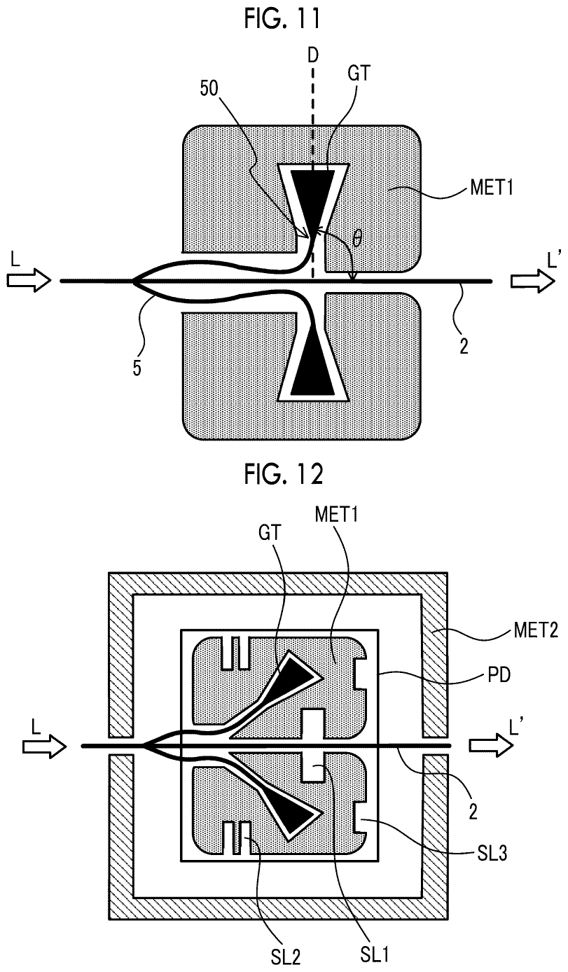

FIGS. 10 and 11 are diagrams for describing an angle θ of the diffraction grating GT disposed in an end portion 50 of the branched waveguide 5. As described using FIG. 6, a quantity of a leaked light beam input into the light-receiving element PD varies depending on an input direction of the stray light (IL1 to IL4) input into the diffraction grating GT.

Thus, the angle θ formed by a direction (a left-right direction in FIG. 10) in which the main waveguide 2 extends at the branch point at which the branched waveguide 5 branches from the main waveguide 2 and a tangential direction D at a position at which the diffraction grating is attached to the end portion of a curve formed by the branched waveguide 5 is set to, for example, 40 degrees or higher. In a case where the angle θ is 40 degrees or higher, an angle of intersection between the leaked light beam LT1 radiating from the branch point of the branched waveguide 5 and the tangential direction D of the diffraction grating GT changes from 0 degrees to 90 degrees. Thus, the quantity of the stray light introduced into the light-receiving element PD from the diffraction grating like the stray light (IL2 or IL3) input into the diffraction grating GT in FIG. 6 is reduced.

For example, in a case where the angle θ is 90 degrees as in FIG. 11, a quantity of the leaked light beam LT1 turning in a direction of the light-receiving element PD is decreased compared to that in the state in FIG. 10. For example, it is most preferable to set the angle θ such that the angle θ satisfies a relational expression of angle θ=90 degrees+β with reference to an angle β at which the leaked light beam LT1 radiates. This is the same as a direction of IL3 in FIG. 6.

Particularly, since a straight line distance from the branch point of the branched waveguide to the diffraction grating GT is approximately 350 μm which is close, the angle θ of the diffraction grating GT is extremely important.

In FIG. 12, many slits (cuts) SL1 to SL3 are formed in a part of the first metal film. Particularly, in a case of using the EB resist, as an area of the metal film is decreased, an area in which the resist is formed is reduced, and productivity is increased.

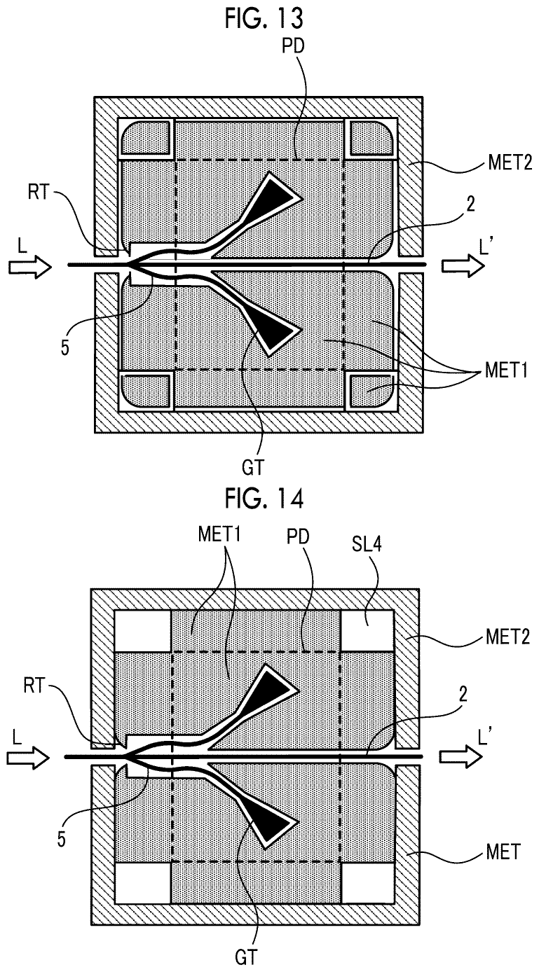

As in FIG. 7, in a case where contours of the light-receiving element PD almost match a region in which the first metal film MET1 is formed, the first metal film can be used for positioning the light-receiving element. As in FIGS. 13 and 14, a pattern having a part in which the metal film is not disposed in accordance with corner portions of the light-receiving element PD can also be formed. In FIG. 13, a mark of the metal film is formed. In FIG. 14, a part without the metal film such as a slit SL4 is formed and indicates positions of the corner portions of the light-receiving element. Reference sign RT illustrated in FIGS. 13 and 14 denotes a metal film that removes an unnecessary light beam propagating near the optical waveguide 2.

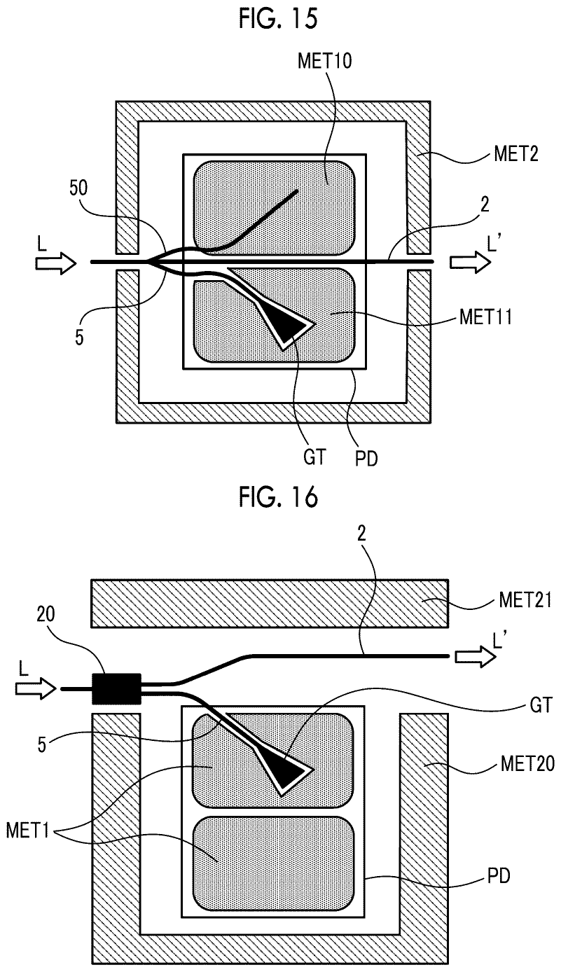

FIGS. 15 and 16 are application examples of the optical waveguide device of the present invention. In FIG. 15, the diffraction grating GT is provided in only one of two branched waveguides. Of course, a first metal film MET11 is provided to surround the diffraction grating. A metal film MET10 is formed to cover the other branched waveguide, and a light wave propagating through the waveguide is absorbed. The light-receiving element PD may have at least a light-receiving surface corresponding to the diffraction grating GT. A light-receiving element having two light-receiving surfaces may also be used in order to reduce types of components.

In FIG. 16, the branched waveguide 5 is formed using a multi-mode interference waveguide (MMI) 20. Even in this case, the diffraction grating GT can be attached to the end portion of the branched waveguide 5. The first metal film MET1 surrounding the diffraction grating GT is also disposed. Of course, in a case where the light-receiving element has a plurality of light-receiving surfaces, it is preferable to form a metal film on a lower side of a light-receiving surface that is not used. A second metal film (MET20 and MET21) may be further formed to surround the light-receiving element PD.

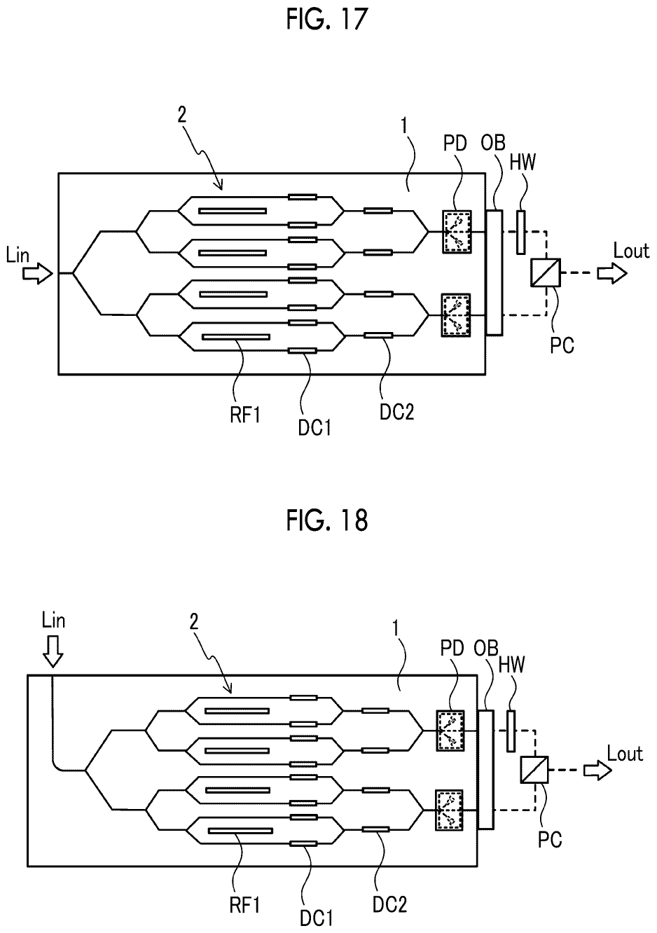

The configuration of the optical waveguide device of the present invention is not limited to a case of using a folded optical waveguide as illustrated in FIG. 4 and is also effective for an optical waveguide device in which an input portion (Lin) and an output portion (Lout) of a light wave are formed on opposite sides of the substrate 1 (chip) as in FIG. 17, and a case where the input portion and the output portion of the light wave are formed on adjacent sides of the substrate 1 (chip) as in FIG. 18. Specifically, while the input portion is disposed away from the light-receiving element PD in the optical waveguide device illustrated in FIGS. 17 and 18, many leaked light beams (stray light) are generated from a branching part or a Y-junction of each Mach-Zehnder type optical waveguide in a state where a plurality of Mach-Zehnder type optical waveguides are used. Even in positioning an optical component OB, the optical component OB is positioned in a state where a predetermined voltage is applied to a modulation electrode RF1 or a DC bias electrode (DC1 and DC2) and where, for example, a quantity of light received by the light-receiving element PD is optimized. Thus, it is extremely important to suppress input of the leaked light beam into the diffraction grating.

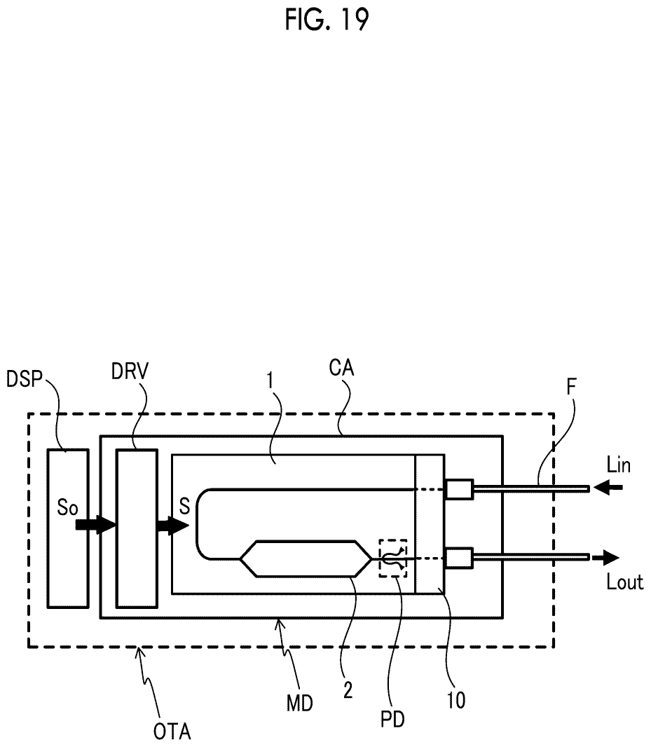

As illustrated in FIG. 19, a compact optical modulation device MD can be provided by accommodating the optical waveguide device (substrate 1) of the present invention inside a case CA of metal or the like and connecting the optical waveguide device to an outside of the case through an optical fiber F. Of course, the optical fiber can not only be directly connected to the input portion or the output portion of the optical waveguide of the substrate 1 but also be optically connected through a space optical system. Reference sign 10 denotes a reinforcing member overlaid on the substrate 1 along an end surface of the substrate 1 and is used in directly joining the optical component such as the optical fiber to the end surface of the substrate 1.

An optical transmission apparatus OTA can be configured by connecting, to the optical modulation device MD, an electronic circuit (digital signal processor DSP) that outputs a modulation signal So causing the optical modulation device MD to perform a modulation operation. A modulation signal S to be applied to the optical waveguide device needs to be amplified. Thus, a driver circuit DRV is used. The driver circuit DRV and the digital signal processor DSP can be disposed outside the case CA or can be disposed inside the case CA. Particularly, disposing the driver circuit DRV inside the case can further reduce a propagation loss of the modulation signal from the driver circuit and achieve a wide bandwidth.

### INDUSTRIAL APPLICABILITY

As described above, according to the present invention, an optical waveguide device that reduces noise light input into a light-receiving element can be provided. An optical modulation device and an optical transmission apparatus using the optical waveguide device can also be provided.

### REFERENCE SIGNS LIST

1 Substrate
2 Optical waveguide
5 Branched waveguide (monitoring optical waveguide)
GT Diffraction grating
MET1 First metal film
MET2 Second metal film
LT1, LT2 Leaked light beam

1. An optical waveguide device comprising:
a substrate on which an optical waveguide is formed, the optical waveguide including a main waveguide and a branched waveguide branching from a part of the main waveguide;
a diffraction grating disposed in an end portion of the branched waveguide;
a light-receiving element disposed on the substrate for receiving a light wave diffracted by the diffraction grating; and
a metal film disposed on the substrate to surround the diffraction grating.

2. The optical waveguide device according to claim 1, wherein the metal film is configured as a part of an electrode formed on the substrate.

3. The optical waveguide device according to claim 1, wherein the metal film is disposed on at least a straight line connecting a branch point at which the branched waveguide branches from the main waveguide to the diffraction grating.

4. The optical waveguide device according to claim 1, wherein an angle formed by a direction in which the main waveguide extends at a branch point at which the branched waveguide branches from the main waveguide and a tangential direction in the end portion of a curve formed by the branched waveguide is 40 degrees or higher.

5. The optical waveguide device according to claim 1, wherein in a plan view of the substrate, the metal film includes a pattern having a part in which the metal film is not disposed along a part of an edge of the light-receiving element, and the pattern also serves as means for positioning the light-receiving element.

6. The optical waveguide device according to claim 1, wherein in a plan view of the substrate, the metal film includes a first metal film that has at least a part disposed inside the light-receiving element, and a second metal film that is configured with only a part disposed outside the light-receiving element and that has a part surrounding the first metal film, and the second metal film is set to have a larger thickness than the first metal film.

7. The optical waveguide device according to claim 6, wherein an electrode formed on the substrate has a shape of multiple tiers, and the first and the second metal films are formed by the metal film of any tier constituting the electrode.

8. The optical waveguide device according to claim 1, wherein a thickness of the metal film disposed inside the light-receiving element in a plan view of the substrate is 2 μm or lower.

9. An optical modulation device comprising:
the optical waveguide device according to claim 1;
a case accommodating the optical waveguide device; and
an optical fiber through which a light wave is input into the optical waveguide device or output from the optical waveguide device.

10. The optical modulation device according to claim 9,
wherein a modulation electrode that modulates a light wave propagating through the optical waveguide is provided in the substrate, and
an electronic circuit that amplifies a modulation signal to be input into the modulation electrode is provided inside or outside the case.

11. An optical transmission apparatus comprising:
the optical modulation device according to claim 10; and
an electronic circuit that outputs a modulation signal causing the optical modulation device to perform a modulation operation.
